(19) United States
(12) Patent Application Publication
(10) Pub. No.: US 2025/0258351 A1
(43) Pub. Date: Aug. 14, 2025

(54) OPTICAL FIBER CABLE

(71) Applicant: SUMITOMO ELECTRIC INDUSTRIES, LTD., Osaka (JP)

(72) Inventors: Yohei SUZUKI, Osaka (JP); Fumiaki SATO, Osaka (JP); Takemasa AKIYAMA, Osaka (JP)

(21) Appl. No.: 19/053,500

(22) Filed: Feb. 14, 2025

(30) Foreign Application Priority Data
Feb. 14, 2024 (JP) 2024-020257

(51) Int. Cl. G02B 6/44

(52) U.S. Cl. CPC G02B 6/443

(57) ABSTRACT

An optical fiber cable includes a cable core including a plurality of optical fibers, at least one tensile strength member provided along the cable core, and a sheath covering the cable core from an outside of the cable core and containing the tensile strength member. The cable core has a non-circular shape. In a cross-sectional view, when a thickness of the sheath at a location where the thickness of the sheath is the largest at a position including the tensile strength member is defined as a first sheath thickness, and a thickness of the sheath at a position facing the tensile strength member across the cable core is defined as a second sheath thickness, the first sheath thickness is larger than the second sheath thickness.

### CROSS-REFERENCE TO RELATED APPLICATIONS

This application is based on and claims priority under 35 USC 119 from Japanese Patent Application No. 2024-020257 filed on Feb. 14, 2024, the entire content of which is incorporated herein by reference.

### TECHNICAL FIELD

The present disclosure relates to an optical fiber cable.

### BACKGROUND ART

U.S. Pat. No. 6,137,936B discloses an optical fiber cable including a plurality of optical fibers, one tensile strength member, and a sheath that covers the plurality of optical fibers from the outside and that contains the one tensile strength member. The tensile strength member allows the cable to bend relatively easily, while providing the cable with the tensile strength and the anti-buckling property.

When an optical fiber cable has a structure in which a cable core is at the center and the tensile strength members are provided on both sides of the sheath, the optical fiber cable is likely to bend in a 90-degree direction with respect to the line connecting the tensile strength members in the cross-sectional view, and tends to have low bending rigidity in that direction. On the other hand, the optical fiber cable is less likely to bend in a direction in which the tensile strength member is located and tends to have high bending rigidity in the direction. That is, the optical fiber cable having the structure described above has bending anisotropy. Such an optical fiber cable is likely to bend in a direction in which the bending rigidity is low when, for example, air is pumped or pushed through a duct, and the cable may buckle midway through the duct.

An optical fiber cable is also known in which three or more tensile strength members are arranged at equal intervals on a sheath in the cross-sectional view. However, in such an optical fiber cable, the distance between the tensile strength member embedded in the sheath and the bending center (in this case, the bending center coincides with the cable center) is large. Therefore, when the cable is bent to a small diameter, a compressive stress is applied to the inside of the bend, and the tensile strength members arranged on the inside are likely to buckle, break, and be crushed. Further, since it is difficult to bend the cable into a small diameter, a large space is required to store the cable.

In order to mount optical fibers at a high density, it is preferable that the optical fiber cable is made thinner and lighter in weight, and the optical fiber diameter has also been reduced from 250 μm in the related art to 200 μm. In order to increase the density, it is useful to reduce the thickness of the sheath. However, when the sheath becomes thinner, the protective function of the sheath is reduced when the cable is bent into a small diameter. Therefore, the tensile strength member provided on the inside is more likely to buckle.

In a configuration in which the cable core is a perfect circle and the sheath contains the tensile strength member, when it is desired to ensure that the sheath thickness is the same at all locations, including the thickness from the tensile strength member to the outer edge of the sheath at the location where the tensile strength member is contained, based on the thinnest part of the sheath in the cross-sectional view, it is difficult to reduce the diameter of the entire cable. When the cable core is restricted to being a perfect circle, it is difficult to secure a large space occupied by the cable core with respect to the entire cable in the cross-sectional view.

### SUMMARY OF INVENTION

Aspect of non-limiting embodiments of the present disclosure relates to provide an optical fiber cable that has a small diameter and that allows optical fibers to be mounted at a high density.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an optical fiber cable including:
a cable core including a plurality of optical fibers;
at least one tensile strength member provided along the cable core; and
a sheath covering the cable core from an outside of the cable core and containing the tensile strength member,
in which the cable core has a non-circular shape, and
in a cross-sectional view, when a thickness of the sheath at a location where the thickness of the sheath is the largest at a position including the tensile strength member is defined as a first sheath thickness, and a thickness of the sheath at a position facing the tensile strength member across the cable core is defined as a second sheath thickness, the first sheath thickness is larger than the second sheath thickness.

### BRIEF DESCRIPTION OF DRAWINGS

Exemplary embodiment(s) of the present invention will be described in detail based on the following figures, wherein:

FIG. 1 is a cross-sectional view perpendicular to the longitudinal direction of an optical fiber cable according to a first embodiment;

FIG. 2 is a cross-sectional view perpendicular to the longitudinal direction of an optical fiber cable according to a comparative example;

FIG. 3 is a cross-sectional view perpendicular to the longitudinal direction of an optical fiber cable according to a modification 1;

FIG. 4 is a cross-sectional view perpendicular to the longitudinal direction of an optical fiber cable according to a modification 2; and

FIG. 5 is a schematic diagram illustrating an evaluation experiment for the water stopping property.

### DESCRIPTION OF EMBODIMENTS

### Description of Embodiments of Present Disclosure

First, embodiments of the present disclosure will be listed and described.

(1) An optical fiber cable according to an aspect of the present disclosure is an optical fiber cable including:
a cable core including a plurality of optical fibers;
at least one tensile strength member provided along the cable core; and
a sheath covering the cable core from an outside of the cable core and containing the tensile strength member,
in which the cable core has a non-circular shape, and
in which, in a cross-sectional view, when a thickness of the sheath at a location where the thickness of the sheath is the largest at a position including the tensile strength member is defined as a first sheath thickness, and a thickness of the sheath at a position facing the tensile strength member across the cable core is defined as a second sheath thickness, the first sheath thickness is larger than the second sheath thickness.

The cable core according to the present disclosure has a non-circular shape, and the first sheath thickness is larger than the second sheath thickness, in the cross-sectional view. Therefore, in the optical fiber cable according to the present disclosure, as compared to the case in which the cable core is a perfect circle, the optical fiber cable can have a small diameter while securing the area occupied by the cable core with respect to the optical fiber cable in the cross-sectional view.

(2) In the above (1),
in the cross-sectional view, the tensile strength member may be provided at one location of the sheath.

According to the present disclosure, when the optical fiber cable is bent, the bending center is shifted toward the tensile strength member, and the distance between the tensile strength member and the bending center is shortened. Therefore, as compared with the case in which the tensile strength member is embedded in two or more locations in the sheath, the tensile strength member is less likely to buckle even when the optical fiber cable is bent to a small diameter. Further, since the optical fiber cable is easily bent to a small diameter, the storage ability of the optical fiber cable is also improved.

(3) In the above (2),
in the cross-sectional view, an outer periphery of the cable core may include two arc portions, the two arc portions including a first arc portion close to the tensile strength member and a second arc portion far from the tensile strength member,
the first arc portion and the second arc portion may be each a convex arc toward an outside of the optical fiber cable from a center of the optical fiber cable, and
a radius of curvature of the first arc portion may be larger than a radius of curvature of the second arc portion.

The outer periphery of the cable core according to the present disclosure includes the first arc portion having a relatively large radius of curvature and the second arc portion having a relatively small radius of curvature. Since such a cable core having a non-circular shape is provided, it is possible to achieve an optical fiber cable that allows the optical fibers to be mounted at a high density and that has a small diameter.

(4) In the above (2),
in the cross-sectional view, an outer periphery of the cable core may include two arc portions, the two arc portions including a first arc portion close to the tensile strength member and a second arc portion far from the tensile strength member,
the first arc portion may be a convex arc toward a center of the optical fiber cable,
the second arc portion may be a convex arc toward an outside of the optical fiber cable from the center of the optical fiber cable, and
a radius of curvature of the first arc portion may be smaller than a radius of curvature of the second arc portion.

The outer periphery of the cable core according to the present disclosure includes the first arc portion having a relatively small radius of curvature and the second arc portion having a relatively large radius of curvature. Since such a cable core having a non-circular shape is provided, it is possible to achieve an optical fiber cable that secures the area occupied by the cable core to be the largest and that has a small diameter.

(5) In any one of the above (1) to (4),
in the cross-sectional view, the first sheath thickness of the sheath may be the largest among a thickness of the sheath.

According to the present disclosure, since the first sheath thickness is the largest in the cross-sectional view, it is possible to secure the sheath around the tensile strength member.

### Details of First Embodiment of Present Disclosure

A specific example of an optical fiber cable according to a first embodiment of the present disclosure will be described with reference to the drawings. The present disclosure is not limited to these exemplifications, but is indicated by the scope of claims, and is intended to include all modifications within a scope and meaning equivalent to the scope of claims.

### Configuration of Optical Fiber Cable

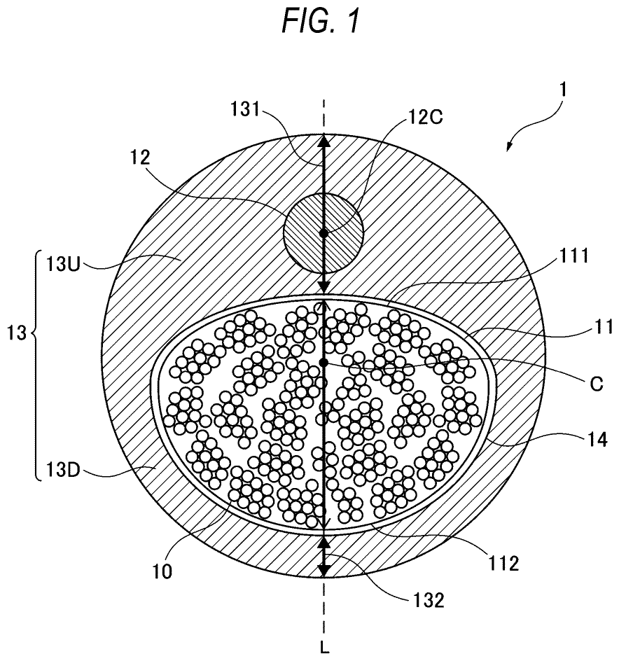

An optical fiber cable 1 according to the present embodiment will be described with reference to FIG. 1. FIG. 1 is a cross-sectional view perpendicular to the longitudinal direction of the optical fiber cable 1.

As illustrated in FIG. 1, the optical fiber cable 1 includes a cable core 11, one tensile strength member 12, a sheath 13, and a press wrapping tape 14. The optical fiber cable 1 has a circular shape in the cross-sectional view. The outer diameter of the optical fiber cable 1 is, for example, 10 mm. The optical fiber cable 1 according to the present embodiment is a slotless optical fiber cable and is a cable for air pumping.

The cable core 11 includes a plurality of optical fiber ribbons 10. In the present embodiment, the cable core 11 includes 24 optical fiber ribbons 10. Each of the optical fiber ribbons 10 includes, for example, 12 optical fibers. The outer diameter of each of the optical fibers is, for example, 165 μm or more and 250 μm or less, and thus the optical fiber is relatively thin. The 12 optical fibers are arranged in a direction orthogonal to the longitudinal direction. Among at least a part of adjacent optical fibers of the optical fiber ribbon 10, a connecting portion in a state in which the adjacent optical fibers are connected and a non-connecting portion in a state in which the adjacent optical fibers are not connected are intermittently provided in the longitudinal direction of the optical fiber. The optical fiber ribbon 10 is an example of a plurality of optical fibers.

The cable core 11 has a non-circular shape in the cross-sectional view. More specifically, the outer periphery of the cable core 11 includes two arc portions, which are a first arc portion 111 close to the tensile strength member 12 and a second arc portion 112 far from the tensile strength member 12, in the cross-sectional view. The first arc portion 111 and the second arc portion 112 are each a convex arc toward the outside from a center C of the optical fiber cable. In other words, the first arc portion 111 is a convex arc toward a first sheath portion 13U to be described later. The second arc portion 112 is a convex arc toward a second sheath portion 13D to be described later. In this way, the direction in which the first arc portion 111 is convex and the direction in which the second arc portion 112 is convex are different from each other.

The radius of curvature of the first arc portion 111 is larger than the radius of curvature of the second arc portion 112. The radius of curvature of the second arc portion 112 may be a value close to the radius of curvature of the outer edge of the sheath 13 of the optical fiber cable 1. The second arc portion 112 forms half (lower half in FIG. 1) of the entire cable core 11 that is far from the tensile strength member 12. The press wrapping tape 14 is wound around the outer periphery of the cable core 11. Instead of the press wrapping tape 14, a bundling string may be wound around the outer periphery of the cable core 11.

The tensile strength member 12 is provided along the cable core 11. The tensile strength member 12 may be linearly arranged along the cable core 11 in the longitudinal direction of the optical fiber cable 1. The tensile strength member 12 is further provided at one location of the sheath 13, in the cross-sectional view.

The tensile strength member 12 is made of a fiber reinforced plastic (FRP). Examples of the fiber reinforced plastic include aramid FRP, glass FRP, and carbon FRP. The tensile strength member 12 has a circular shape in the cross-sectional view. The diameter of the tensile strength member 12 is, for example, 2 mm.

The sheath 13 covers the cable core 11 from the outside and contains the tensile strength member 12. The base resin of the sheath 13 according to the present embodiment is an ethylene-vinyl acetate copolymer resin (an EVA resin). The sheath 13 may contain a flame-retardant inorganic material. As a flame-retardant inorganic material, the sheath 13 contains, for example, magnesium hydroxide or aluminum hydroxide.

In the cross-sectional view, the thickness of the sheath 13 is not uniform. The sheath 13 includes the first sheath portion 13U having a large thickness and the second sheath portion 13D having a small thickness. The first sheath portion 13U is a sheath that contains the tensile strength member 12. The first sheath portion 13U is a sheath portion that occupies half (upper half in FIG. 1) of the entire optical fiber cable 1 that is closer to the tensile strength member 12 than is the second sheath portion 13D, in the cross-sectional view. In the first sheath portion 13U, the thickness of the sheath at a location where the thickness (the distance from the inner edge to the outer edge of the sheath 13) of the sheath 13 is the largest at a position including the tensile strength member 12 is defined as a first sheath thickness 131. When a straight line that connects a center 12C of the tensile strength member 12 and the center C of the optical fiber cable 1 is defined as L, the first sheath thickness 131 is the thickness of the first sheath portion 13U on the straight line L.

A second sheath thickness 132 is the thickness of the sheath at a position in the second sheath portion 13D that faces the tensile strength member 12 across the cable core 11. In the cross-sectional view, the second sheath portion 13D is located between the outer edge of the optical fiber cable 1 and the press wrapping tape 14 corresponding to the second arc portion 112 of the cable core 11. In other words, in the cross-sectional view, the second sheath portion 13D is not only located on the opposite side of the tensile strength member 12 across the cable core 11, but is also the sheath portion of the other half (the lower half in FIG. 1) of the entire optical fiber cable 1 that is farther from the tensile strength member 12 than is the first sheath portion 13U. The thickness of the second sheath portion 13D may be uniform over half of the entire optical fiber cable 1. In the present embodiment, “uniform” does not only refer to a case in which the thickness is strictly uniform, but also includes a case in which the difference between the two is sufficiently small and the thickness is evaluated as being substantially uniform.

In the present embodiment, the first sheath thickness 131 is larger than the second sheath thickness 132. The second sheath thickness 132 is, for example, 1 mm. The first sheath thickness 131 is, for example, 1.1 times or more and 2.8 times or less the diameter of the tensile strength member 12. In the present embodiment, the first sheath thickness 131 of the sheath 13 is the largest, in the cross-sectional view.

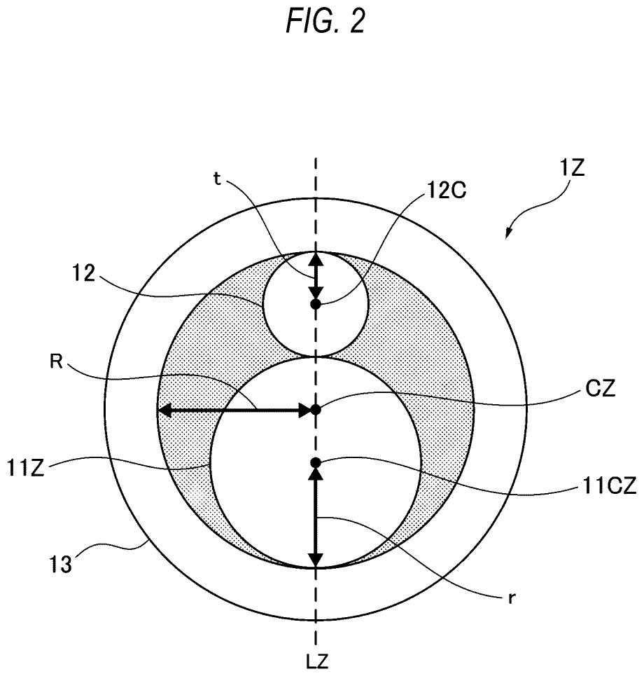

Next, the area occupied by the cable core 11 with respect to the optical fiber cable 1 according to the present embodiment will be described with reference to FIG. 2. FIG. 2 is a cross-sectional view perpendicular to the longitudinal direction of an optical fiber cable 1Z according to a comparative example. In the configuration shown in FIG. 2, the same components as those shown in FIG. 1 are denoted by the same reference signs, and the description thereof is omitted. In FIG. 2, an unfilled portion (a white portion) indicates a sheath to be ensured to protect the cable core 11.

As shown in FIG. 2, the optical fiber cable IZ according to the comparative example includes a cable core 11Z having a circular shape, unlike the cable core 11 having a non-circular shape. Further, in the optical fiber cable 1Z, a center CZ of the optical fiber cable 1Z, the center 12C of the tensile strength member 12, and a center 11CZ of the cable core 11Z are arranged on a straight line LZ, and the tensile strength member 12 and the cable core 11Z are in contact with each other on the straight line LZ. The radius of the cable core 11Z is r, the radius of the tensile strength member 12 is t, and the radius of the circle formed by adding the diameter of the cable core 11Z and the diameter of the tensile strength member 12 is R. At this time, the area of the gray filled portion in FIG. 2 is an area obtained by subtracting the area of the tensile strength member 12 and the area of the cable core 11Z from the area of the circle having a radius R, which is 2πtr. In this way, when the cable core 11Z is a perfect circle, the area of 2πtr cannot be used for the cable core 11Z. As a result, it is difficult to increase the density of the optical fiber cable 1Z.

On the other hand, in the optical fiber cable 1 according to the present embodiment, the cable core 11 has a non-circular shape. More specifically, the outer periphery of the cable core 11 includes the first arc portion 111 close to the tensile strength member 12 and the second arc portion 112 far from the tensile strength member 12. The first arc portion 111 and the second arc portion 112 are each a convex arc toward the outside from the center C of the optical fiber cable 1. The radius of curvature of the first arc portion 111 is larger than the radius of curvature of the second arc portion 112. Since the cable core 11 has such a non-circular shape, as compared to the case in which the cable core is a perfect circle, the area occupied by the cable core 11 with respect to the entire optical fiber cable 1 in the cross-sectional view can be secured to be large, up to a maximum of 2πtr. Accordingly, it is easy to increase the density of the optical fiber cable 1.

Further, in the present embodiment, the first sheath thickness 131 is larger than the second sheath thickness 132 in the cross-sectional view. Therefore, it is possible to secure the sheath 13 around the tensile strength member 12.

### Modification 1

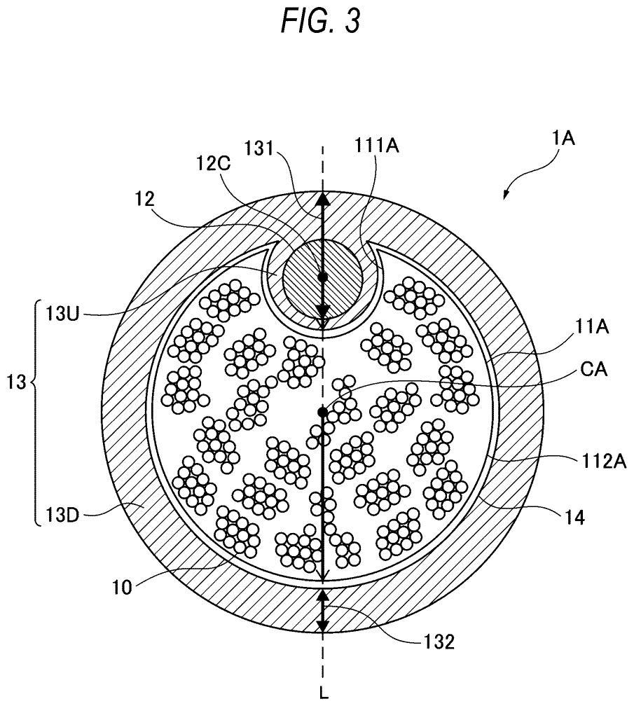

An optical fiber cable 1A according to a modification 1 will be described with reference to FIG. 3. In the configuration shown in FIG. 3, the same components as those shown in FIG. 1 are denoted by the same reference signs, and the description thereof is omitted.

FIG. 3 is a cross-sectional view perpendicular to the longitudinal direction of the optical fiber cable 1A. In the cable core 11 illustrated in FIG. 1, the first arc portion 111 and the second arc portion 112 are each a convex arc toward the outside from the center C of the optical fiber cable 1. On the other hand, in a cable core 11A of the optical fiber cable 1A illustrated in FIG. 3, a first arc portion 111A is a convex arc toward a center CA of the optical fiber cable 1A, and a second arc portion 112A is a convex arc toward the outside from the center CA of the optical fiber cable 1A. In other words, the first arc portion 111A and the second arc portion 112A are convex arcs toward the second sheath portion 13D.

Further, in the cable core 11A of the optical fiber cable 1A, the first arc portion 111A surrounds a part of the outer periphery of the tensile strength member 12 from the outside. The radius of curvature of the first arc portion 111A is smaller than the radius of curvature of the second arc portion 112A.

According to the present modification, the area occupied by the cable core 11A with respect to the optical fiber cable 1A can be secured to be the largest.

### Modification 2

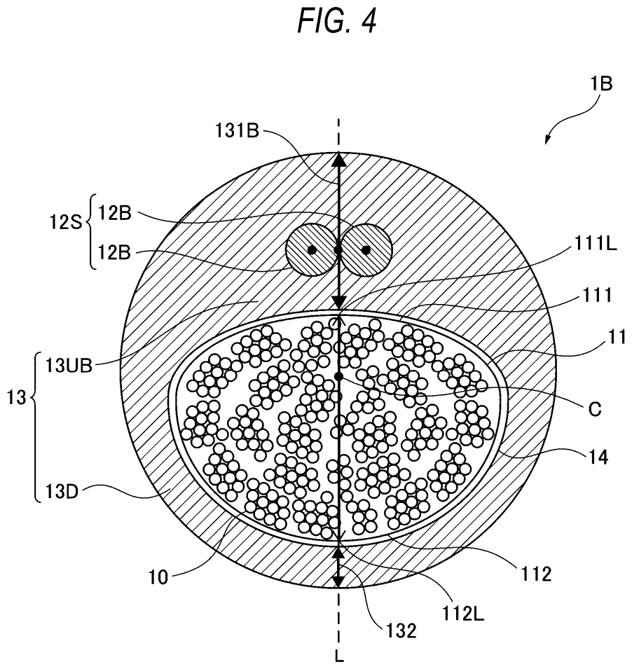

An optical fiber cable 1B according to a modification 2 will be described with reference to FIG. 4. In the configuration shown in FIG. 4, the same components as those shown in FIG. 1 are denoted by the same reference signs, and the description thereof is omitted.

FIG. 4 is a cross-sectional view perpendicular to the longitudinal direction of the optical fiber cable 1B. The optical fiber cable 1 illustrated in FIG. 1 includes one tensile strength member 12. On the other hand, in the optical fiber cable 1B illustrated in FIG. 4, two tensile strength members 12B are provided at one location of the sheath 13, in the cross-sectional view.

The two tensile strength members 12B form a pair of tensile strength member sets 12S. The pair of tensile strength member sets 12S are provided at one location of the sheath 13. The two tensile strength members 12B may be in contact with each other or may be separated from each other. Each of the tensile strength members 12B has a circular shape in the cross-sectional view. The diameter of each of the tensile strength members 12B is, for example, 1.2 mm.

In the modification 2, the sheath 13 includes a first sheath portion 13UB having a large thickness and the second sheath portion 13D having a small thickness. The first sheath portion 13UB contains two tensile strength members 12B. In the first sheath portion 13UB, the thickness of the sheath 13 at a location where the thickness of the sheath 13 is the largest at a position including the tensile strength member sets 12S is defined as a first sheath thickness 131B.

In the optical fiber cable 1B according to the present modification, the two tensile strength members 12B (the pair of tensile strength member sets 12S) are provided at one location of the sheath 13. Therefore, when the optical fiber cable 1B is bent, the bending center is shifted toward the two tensile strength members 12B, and the distance between the two tensile strength members 12B and the bending center is shortened. Therefore, the two tensile strength members 12B are less likely to buckle. Since the optical fiber cable 1B is easily bent to a small diameter, the storage ability of the optical fiber cable 1B is also improved.

Although the present disclosure has been described in detail with reference to the specific embodiments, it is apparent to those skilled in the art that various changes and modifications can be made without departing from the spirit and scope of the present disclosure. In addition, the number, positions, shapes, and the like of the constituent members described above are not limited to those in the above embodiments, and can be changed to the numbers, positions, shapes, and the like suitable for carrying out the present disclosure.

The sheath 13 of the optical fiber cable 1, the optical fiber cable 1A, and the optical fiber cable 1B can be formed by tubing set up extrusion. More specifically, in the tubing set up extrusion, resin is subjected to tubing set up from a resin flow path between the point and the die, and the resin coats the cable cores 11 and 11A from the outside and also coats the tensile strength member 12 so as to contain the tensile strength member 12. At this time, the shape of the opening of the die, through which the cable cores 11 and 11A pass, is non-circular. In this way, by making the shape of the opening of the die non-circular, it is possible to form the cable cores 11 and 11A in the shape as exemplified in the present embodiment.

### Evaluation Experiments

The pumping distance of the optical fiber cable 1 according to the first embodiment was evaluated. As a method for evaluating the pumping distance, a microduct pumping test defined by the International Electrotechnical Commission (IEC) was used. In the pumping test, a general-purpose microduct was used. The inner diameter of the duct is 13 mm. The total pumping distance in the duct is set to 1000 m or more, and the duct is folded back every 100 m. The radius of curvature of the duct is 40 times the outer diameter of the duct. The pressure in the duct is 1.3 MPa to 1.5 MPa. As a result of the measurement experiment, it was confirmed that the pumping distance of the optical fiber cable 1 was 1000 m or more.

Further, the transmission loss characteristics of the optical fiber cable 1 according to the first embodiment were evaluated. As an evaluation method, light having a wavelength of 1.55 μm was incident on the optical fiber cable 1, and it was confirmed that the transmission loss value was 0.25 dB/km or less.

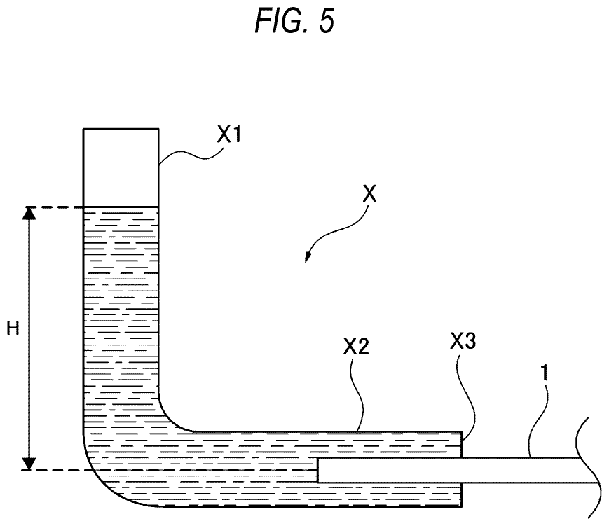

Further, the water stopping property of the optical fiber cable 1 according to the first embodiment was evaluated. FIG. 5 is a schematic diagram illustrating an evaluation experiment for the water stopping property. As illustrated in FIG. 5, a hose X includes a cylindrical portion X1 that extends in the vertical direction and a cylindrical portion X2 that extends in the horizontal direction. The diameter of the hose X is larger than the diameter of the optical fiber cable 1. A waterproof seal X3 is provided at the end portion of the cylindrical portion X2, which holds the optical fiber cable 1 and seals the hose X to prevent water stored in the hose X from leaking. Since the waterproof seal X3 is provided, the hose X can store liquid such as water or artificial seawater in the cylindrical portion X1 and the cylindrical portion X2.

In the evaluation experiment, first, the optical fiber cable 1 serving as a sample is held at the end portion of the cylindrical portion X2, and tap water or artificial seawater is stored inside the hose X. At this time, a height H between the center C of the held optical fiber cable 1 and the water surface of the cylindrical portion X1 is 1 m. In a state in which tap water or artificial seawater was stored inside the hose X, the optical fiber cable 1 was left at room temperature for 24 hours. Thereafter, the optical fiber cable 1 was removed from the end portion of the cylindrical portion X2, and the length of the optical fiber cable 1 that was submerged in tap water or artificial seawater in the longitudinal direction was measured. It was confirmed that the water stopping property of the optical fiber cable 1 was such that the length of the optical fiber cable 1 that was submerged in water was 3 m or less.

What is claimed is:

1. An optical fiber cable comprising:
a cable core including a plurality of optical fibers;
at least one tensile strength member provided along the cable core; and
a sheath covering the cable core from an outside of the cable core and containing the tensile strength member,
wherein the cable core has a non-circular shape, and
wherein, in a cross-sectional view, when a thickness of the sheath at a location where the thickness of the sheath is the largest at a position including the tensile strength member is defined as a first sheath thickness, and a thickness of the sheath at a position facing the tensile strength member across the cable core is defined as a second sheath thickness, the first sheath thickness is larger than the second sheath thickness.

2. The optical fiber cable according to claim 1,
wherein, in the cross-sectional view, the tensile strength member is provided at one location of the sheath.

3. The optical fiber cable according to claim 2,
wherein, in the cross-sectional view, an outer periphery of the cable core includes two arc portions, the two arc portions including a first arc portion close to the tensile strength member and a second arc portion far from the tensile strength member,
wherein the first arc portion and the second arc portion are each a convex arc toward an outside of the optical fiber cable from a center of the optical fiber cable, and
wherein a radius of curvature of the first arc portion is larger than a radius of curvature of the second arc portion.

4. The optical fiber cable according to claim 2,
wherein, in the cross-sectional view, an outer periphery of the cable core includes two arc portions, the two arc portions includes a first arc portion close to the tensile strength member and a second arc portion far from the tensile strength member,
wherein the first arc portion is a convex arc toward a center of the optical fiber cable,
wherein the second arc portion is a convex arc toward an outside of the optical fiber cable from the center of the optical fiber cable, and
wherein a radius of curvature of the first arc portion is smaller than a radius of curvature of the second arc portion.

5. The optical fiber cable according to claim 1,
wherein, in the cross-sectional view, the first sheath thickness of the sheath is the largest among a thickness of the sheath.
